(19) United States
(12) Patent Application Publication
(10) Pub. No.: US 2026/0258274 A1
(43) Pub. Date: Sep. 3, 2026

(54) COATING COMPOSITION, COATED MEMBER, AND METHOD FOR PRODUCING COATED MEMBER

(71) Applicant: Hitachi Astemo, Ltd., Ibaraki (JP)

(72) Inventors: Satoshi FUJINAKA, Ibaraki (JP); Takafumi NAKAGAKI, Ibaraki (JP)

(21) Appl. No.: 18/878,810

(22) PCT Filed: Jul. 12, 2022
(86) PCT No.: PCT/JP2022/027374

§ 371 Date: Dec. 24, 2024

(51) Int. Cl. C09D 163/00; B05D 1/28; C09D 7/40; C09D 7/65

(52) U.S. Cl. CPC C09D 163/00; B05D 1/28; C09D 7/65; C09D 7/70; B05D 2504/00; B05D 2602/00

(57) ABSTRACT

A coating composition according to the present disclosure includes: a resin including an epoxy resin as a main component; and a cellulose nanofiber in which a functional group different from a hydroxyl group is introduced into a hydroxyl group site in a glucose unit at an introduction rate of 0% or more and 10% or less. Herein, a concentration of the cellulose nanofiber relative to a solid content is 0.05 mass % or more and 10 mass % or less, and the coating composition has a viscosity of 2.8 dPa·s or more and 350 dPa·s or less. An amount of at least one of the epoxy resin or a solvent is adjusted such that a content of the cellulose nanofiber is 0.03 mass % or more and 10 mass % or less with respect to the total coating composition.

### CROSS-REFERENCE TO RELATED APPLICATION

This application is a U.S. National Stage Application under 35 U.S.C § 371 of International Patent Application No. PCT/JP2022/027374 filed on 12 Jul. 2022, the disclosure of which is hereby incorporated by reference in its entirety.

### TECHNICAL FIELD

The present disclosure relates to a coating composition, a coated member, and a method for producing a coated member.

### BACKGROUND ART

The abstract of Patent Document 1 describes that “An epoxy resin coating composition of the present invention is characterized by containing an epoxy resin, a curing agent for the epoxy resin, and a cellulose nanofiber. Further, a coating reinforcing agent of the present invention is characterized in that the coating reinforcing agent is formed by dispersing the cellulose nanofiber in a polyester based resin. Moreover, a method for producing the coating reinforcing agent of the present invention is characterized by pressurizing and kneading a mixture of the polyester based resin and cellulose fiber powder, and a method for producing an epoxy resin coating composition of the present invention is characterized by blending said coating reinforcing agent.”

### PRIOR ART DOCUMENT

### Patent Document

Patent Document 1: JP2019-183004

### SUMMARY OF INVENTION

### Problem to be Solved by Invention

Among members to which a coating composition is coated, known are members having surfaces extending in various directions, such as a propeller shaft. Among those members, when a coating composition is applied to a surface of such a member thus angled with respect to a horizontal direction, the applied coating composition is likely to drip along the surface. However, the technique described in Patent Document 1 does not take dripping of the applied coating composition into consideration. On the other hand, simply increasing a viscosity of the coating composition to prevent dripping may result in reduced coating properties.

A problem to be solved by the present disclosure is to provide a coating composition, a coated member, and a method for producing a coated member that can achieve both prevention of dripping during coating and good coating properties.

### Means for Solving Problem

A coating composition of the present disclosure includes a resin containing an epoxy resin as a main component, and a cellulose nanofiber to which a functional group different from a hydroxyl group has been introduced at a rate of 0% or more and 10% or less. A concentration of the cellulose nanofiber relative to a solid content is 0.05 mass % or more and 10 mass % or less. A viscosity of the coating composition is 2.8 dPa·s or more and 350 dPa·s or less. Other solutions will be described hereinafter in embodiments for carrying out the invention.

### Effect of Invention

According to the present disclosure, it is possible to provide a coating composition, a coated member, and a method for producing a coated member, which can achieve both prevention of dripping during coating and good coating properties.

### BRIEF DESCRIPTION OF DRAWINGS

FIG. 1 is a cross-sectional view of a coated member of the present disclosure.

FIG. 2 is a flowchart showing a method for producing a coated member of the present disclosure.

### EMBODIMENTS FOR CARRYING OUT INVENTION

Hereinafter, modes for carrying out the present disclosure (hereinafter referred to as embodiments) will be described with reference to the drawings. In the following description of one embodiment, other embodiments that are applicable to the one embodiment will be also described appropriately. The present disclosure is not limited to the one embodiment described hereinafter, and different embodiments may be combined with each other or modified as desired without significantly impairing effects of the present disclosure. Further, the same components are given the same reference numeral and duplicated explanations are omitted. Moreover, components that have the same function are given the same name. Contents shown in the drawings are merely schematic, and for the sake of illustration, actual constructions may be changed without significantly impairing effects of the present disclosure. Similarly, a part of components may be omitted or modified between the drawings.

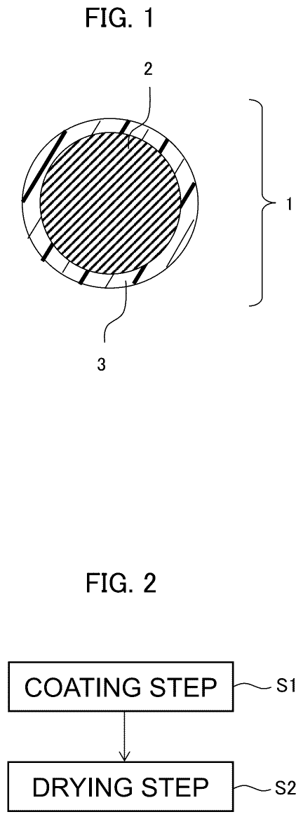

A coating composition of the present disclosure includes a resin containing an epoxy resin as a main component and a cellulose nanofiber (i.e., CNF). The coating composition of the present disclosure is coated, for example, to a substrate 2 (see FIG. 1). After coating and drying, a coated member 1 (see FIG. 1) is obtained.

The epoxy resin is included at the largest rate of all resins in the coating composition of the present disclosure. All of the resins in the coating composition of the present disclosure may be epoxy resin. The epoxy resin is, for example, a modified epoxy resin, preferably a one liquid curing type of epoxy resin. Such an epoxy resin can be produced, for example, from bisphenol A and epichlorohydrin. A number average molecular weight of the epoxy resin is not limited, but can be, for example, 100 or more and 5,000 or less. The resin may contain any resin other than the epoxy resin as long as the effects of the present disclosure are not significantly impaired.

The CNF is obtained, for example, by finely cutting cellulose fibers bonded with glucose via β-1,4 bond. The CNF is preferably a naturally derived material, and can be obtained, for example, by mechanically defibrating cellulose fibers in pulp obtained from hardwood.

The CNF of the present disclosure has an introduction rate of a functional group different from a hydroxyl group to a hydroxyl group site in a glucose unit is 0% or more and 10% or less. Including such a CNF can prevent changes in physical properties of the CNF caused by functional groups other than the hydroxyl group. Thereby, an influence of changes in the physical properties of the CNF on a coated product can be prevented. In the case of naturally derived CNF, the introduction rate is usually 0% or more and 10% or less, preferably approximately 0% (i.e., almost not substituted). Functional groups that can be introduced include, but are not limited to, for example, a carboxyl group that can be generated by oxidation of a —CH₂OH group. Whether or not a functional group other than the functional group derived from cellulose is introduced can be determined by, for example, spectrum analysis based on infrared absorption spectroscopy.

An average fiber diameter of the CNFs is not particularly limited to, but is, for example, 4 nm or more and 100 nm or less. Setting the average fiber diameter to 4 nm or more can prevent chemical modifications of the CNF and changes in physical properties of the CNF due to the modifications. Additionally, water resistance of the coated product can be improved by a coated film 3 (see FIG. 1). On the other hand, setting the average fiber diameter to 100 nm or less makes it easier to disperse CNF particles uniformly in the coating composition. Thereby, the substrate 1 (see FIG. 1) can be easily coated. Further, after coating, effects of the CNF can be exerted throughout the entire coating composition. An average fiber diameter of the CNFs can be determined, for example, by extracting any 10 CNFs from a TME image including cross sections of the CNFs, thereby calculating an average value of respective CNF diameters.

In the coating composition of the present disclosure, the resin and CNF are typically included as a solid content. A “solid content” referred to here is a material that contributes to formation of the coated film after drying (i.e., a material that remains as a solid. A material that functions as a coated film.). Thus, the solid content is typically a content excluding volatile components (such as solvents) in the coating composition of the present disclosure. When the coating composition contains only a resin, a CNF and a solvent, the solid content thereof corresponds to a total amount of the resin and the CNF. In addition, when the coating composition further contains any optional components (i.e., such as a pigment, a metal particle excluding volatile components), a solid content thereof corresponds to a total amount of the resin, the CNF, and the optional components. Any of the components may be dissolved or dispersed in a solvent. Further, the resin and the CNF may be respectively dissolved in a solvent or dispersed in a solvent.

A concentration of the CNF relative to the solid content is 0.05 mass % or more, with the upper limit being 9 mass % or less, preferably 0.3 mass % or less. Setting the concentration to 0.05 mass % or more can not only prevent dripping during coating and also decrease a viscosity of the coating composition. This procedure allows easier coating of the coating composition and provides good coating properties. On the other hand, setting the concentration to 10 mass % or less can prevent the viscosity of the coating composition from becoming excessively high, resulting in improvement of good coating properties. Further, setting the concentration to 0.3 mass % or less can improve acid resistance of the coated film 3 (FIG. 1).

The coating composition of the present disclosure has a viscosity of 2.8 dPa·s or more and 350 dPa·s or less. Setting the viscosity within the range can not only prevent dripping during coating and also achieve good coating properties. The viscosity can be measured, for example, by using a Brookfield viscometer.

Next, relationships between a CNF concentration and a viscosity will be described. In the coating composition of the present disclosure, the viscosity thereof is determined by a sum of a viscosity of a coating material itself and a viscosity resulting from a high viscosity due to a network formed by the CNFs. Therefore, if the viscosity of the coating material alone is low, the final viscosity will be relatively lower even after adding the CNFs. For this reason, effects of adding the CNFs, namely, inhibition of dripping due to a network structure of the CNFs and inhibition of dripping due to the final viscosity of the coating composition, are different actions. For this reason, there is not necessarily a correlation between the CNF concentration and the viscosity.

It is preferable to adjust an amount of at least one of the epoxy resin and the solvent so that the CNF content relative to the solid content is 0.12 mass % or more and the upper limit thereof is 6 mass % or less, preferably 0.3 mass % or less. Setting the CNF content to 0.03 mass % or more and 10 mass % or less makes it possible to not only prevent dripping during coating of the coating composition and also achieve good coating properties. In particular, setting the CNF content to 0.03 mass % or more can reduce fluidity of the coating composition when left standing due to the three-dimensional network structure of the CNFs. Therefore, it is expected that unevenness of the coated film 3 (see FIG. 1) can be prevented. As a result, improvements in chipping resistance, hardness of the coated film and impact resistance are expected by the reinforcing effect of such a three-dimensional network structure. Further, setting the content to 0.3 mass % or less can improve acid resistance of the coated film 3 (see FIG. 1).

Solvents that can be used are not particularly limited as long as the solvents dissolve the epoxy resin and disperse the CNFs. Examples of the solvent include organic solvents such as triethylamine, ethylene glycol monopropyl ether, 3-methyl-3-methoxybutanol, and ethylene glycol monoethyl ether. As the solvents, an aqueous solvent may be used in combination with an organic solvent. The aqueous solvent may include, for example, at least one selected from water and any aqueous solution. The solvent may be used alone or in any combination and ratio of two or more types of solvents.

FIG. 1 is a cross-sectional view of a coated member 1 of the present disclosure. The coated member 1 includes a substrate 2 and a coated film 3 disposed on a surface of the substrate 2. Although the details will be described later, the substrate 2 is, for example, a propeller shaft but it is not limited thereto. FIG. 1 illustrates, as an example, a cross-sectional view in a direction vertical to the rotation axis of the propeller shaft (i.e., in a vertical direction to a plane of FIG. 1).

The coated film 3 contains the resin and the CNF. As described above, the resin contains an epoxy resin as a main component. As described above, the CNF has an introduction rate of a functional group other than a hydroxyl group thus introduced into a hydroxyl group site in a glucose unit of 0% or more and 10% or less. A concentration of the CNF in the coated film 3 is 0.05 mass % or more and 9 mass % or less. The coated film 3 is obtained, for example, by coating the coating composition of the present disclosure to the substrate 2 and drying a coated substrate 2. Details of these resins and CNF are similar to those described for the coating composition above, and therefore will be omitted.

The substrate 2 includes, for example, a curved surface, and the coated film 3 is disposed on a surface of the curved surface. As described above, the coating composition of the present disclosure prevents dripping from occurring during coating. Therefore, even when the coating composition is coated to a curved surface of the substrate 2, dripping can be prevented, allowing the coated film 3 with a uniform thickness to be easily obtained. Herein, the substrate 2 may include a flat surface, and the coated film 3 may be formed on the flat surface. In particular, as described in detail later, occurrence of dripping can be prevented by coating a flat surface thus arranged with an inclination in a horizontal direction. Such a substrate 2 is, for example, a propeller shaft as described above.

A thickness of the coated film 3 is, for example, 30 mm or more. Setting the thickness of the coated film 3 to this range can easily exert functions caused by the resin and the CNF, for example, corrosion resistance or the like. The upper limit of the thickness of the coated film 3 is not particularly limited to, but the thickness can be, for example, 100 mm or less.

FIG. 2 is a flowchart showing a method for producing the coated member 1 (see FIG. 2) of the present disclosure (hereinafter, referred to as a production method of the present disclosure). The production method of the present disclosure includes a coating step S1 and a drying step S2.

The coating step S1 is a step of coating the coating composition of the present disclosure onto the surface of a stationary substrate 2 (see FIG. 1). A concentration of the CNF relative to a solid content in the coating composition is equal to a CNF content in the coated film 3 (see FIG. 1). The method of coating is not particularly limited to, but the coating can be carried out by any method, such as spraying, brushing and so on. In particular, the coating step S1 is preferably carried out by a method using at least one of a spray and a brush. As described above, the coating composition of the present disclosure is less likely to drip during coating. Therefore, dripping can be prevented by a simple method. In particular, the coating composition of the present disclosure having the above described viscosity is difficult to be used in a spray method. However, since the CNF has thixotropy, fluidity of the coating composition of the present disclosure increases during spray coating, allowing the spray coating to be performed.

As for an arrangement of the substrate 2, the substrate 2 may be arranged so that a surface of the substrate 2 extends in a horizontal direction. Alternatively, the surface of the substrate 2 may be arranged with an angle to the horizontal direction. In particular, the coating step S1 is preferably carried out by coating the coating composition of the present disclosure onto a surface having an angle θ with respect to the horizontal direction. This procedure can prevent dripping from occurring even when the substrate 2 is arranged in a manner that causes dripping by a conventional coating composition. The angle θ here is greater than 0°, and the upper limit is, for example, less than 90°, preferably 45° or less, and more preferably 30° or less.

When coating a flat surface, it is preferable to arrange the flat surface so that the flat surface forms an angle θ with respect to the horizontal direction. For example, as shown in FIG. 1, when coating a curved surface, a tangent of the curved surface is set as a reference. Herein, the angle θ is an angle of the tangent with respect to the horizontal direction. The angle θ may be the same or may vary across the entire coating surface. When coating a curved surface, the angle θ usually differs depending on the coating position.

The coating step S1 is preferably carried out by coating the coating composition of the present disclosure so that a thickness of the coated film 3 (see FIG. 1) formed after drying is, for example, 20 mm or more, preferably 30 mm or more. This procedure can sufficiently exert functions of the coated film 3 thus formed by coating and drying the coating composition of the present disclosure. Here, whether or not a thickness of the coated film reaches a desired one corresponding to how thick the coating composition of the present disclosure is coated can be determined. For example, it can be determined based on the concentration of the solid content in the coating composition of the present disclosure. That is, the higher the concentration of the solid content, the thicker the coated film will be, and the lower the concentration of the solid content, the thinner the coated film will be.

The drying step S2 is a step of drying the substrate 2 in a stationary state, in which the coating composition of the present disclosure has been coated to the substrate 2. The drying step S2 is preferably carried out at room temperature, specifically in an atmosphere at 15° C. or higher and 30° C. or lower. This procedure can remove a solvent from the coating composition while reducing influence on the resin and the CNF in the coating composition.

When the substrate 2 has a surface extending vertically downward, if a conventional coating composition is used for coating, the coating composition is likely to drip due to the action of gravity immediately occurring just after the coating. Dripping of the coating composition leads to a reduction in the thickness of the coated film 3, resulting in a decrease in corrosion resistance thereof. On the other hand, if a coated amount of the coating composition is increased in order to ensure the thickness of the coated film 3, the weight of the coated member 1 increases, the number of steps required for production increases, and a total time required up to the drying step increases. Further, it may be assumed to accelerate the drying process when drying by using hot air to shorten the drying time. However, the use of hot air results in an increase in a size of the production facilities and the number of the steps. On the contrary, the coating composition of the present disclosure, as described above, can achieve both prevention of dripping during coating and good coating properties. These advantages can reduce a weight of the coated member 1 while ensuring sufficient corrosion resistance, and further, prevent an increase in the number of the steps at the time of production.

### EXAMPLES

Hereinafter, the present disclosure will be described more specifically with reference to examples. The preparation and evaluation described below were all carried out under conditions at 23° C. Further, there is a temperature range of +2° C. according to JIS Z8703.

### <Preparation of Coating Composition of Present Disclosure>

Physical properties of the CNF used are as follows.
Average fiber diameter: 10 nm to 100 nm
Chemical modification: None (0% of introduction rate)
Composition: Cellulose alone
Main raw material: Hardwood (natural origin)
Defibration method: Mechanical defibration (physical defibration)
Manufacturer: Daio Paper Corporation

A resin used was a modified epoxy resin. A concentration of the resin in the entire coating composition was a predetermined concentration within a range from 15 mass % to 25 mass %. A solvent used was a mixture of water and an organic solvent. A concentration of water in the entire coating composition was set to a predetermined concentration within a range from 30 mass % to 40 mass %, and a concentration of the organic solvent was set to a predetermined concentration within a range from 10 mass % to 15 mass %. The organic solvent was a mixed solvent of triethylamine, ethylene glycol monopropyl ether, 3-methyl-3-methoxybutanol, and ethylene glycol monoethyl ether.

The CNF, resin, and solvent described above were thoroughly mixed to prepare the coating composition of the present disclosure. Dripping properties and coating properties, when the CNF concentration relative to the solid content of the coating composition and the viscosity of the coating composition were adjusted to the values in Table 1 below, were shown in Table 1 below. The dripping properties and coating properties were evaluated in the same manner as Example 1 below, unless otherwise specified.

TABLE 1

| | CNF | | | |
|---|---|---|---|---|
| | Concentration | Viscosity | Dripping | Coating |
| Test No. | (mass %) | (Pa · s) | Properties | Properties |
| 1 | 0.03 | 2.7 | X | ◯ |
| 2 | 0.08 | 2.8 | Δ | ◯ |
| 3 | 0.09 | 3.4 | Δ | ◯ |
| 4 | 0.15 | 2.8 | ◯ | ◯ |
| 5 | 0.62 | 2.8 | ◯ | ◯ |
| 6 | 1.13 | 3.5 | ◯ | ◯ |
| 7 | 2.30 | 120 | ◯ | ◯ |
| 8 | 3.73 | 170 | ◯ | ◯ |
| 9 | 4.56 | 220 | ◯ | ◯ |
| 10 | 5.37 | 240 | ◯ | ◯ |
| 11 | 6.71 | 260 | ◯ | Δ |
| 12 | 8.05 | 320 | ◯ | Δ |
| 13 | 9.68 | 380 | ◯ | X |

In Table 1, symbols of dripping properties and coating properties mean as follows:

### Dripping Properties:

| | |
|---|---|
| ◯ | No dripping occurred. |
| Δ | Basically, no dripping occurred, but as the film |
| | thickness increased, dripping occurred. |
| X | Dripping occurred immediately after coating. |

### Coating Properties:

| | |
|---|---|
| ◯ | Coating was possible without any scratch. |
| Δ | There was a tendency for scratches to easily occur, and |
| | the coated film had uneven brush marks, but the base |
| | material did not show through to the outside, resulting |
| | in successful coating. |
| X | Significant scratches occurred or the coating composition |
| | did not come off the brush, resulting in failure in coating. |

### <Evaluation of Dripping and Coating Properties Based on CNF Concentration and Viscosity>

The following evaluations were performed using a part of the coating compositions among the coating compositions shown in Table 1 above.

### Example 1 (Corresponding to Test No. 12 in Table 1 Above)

A coating composition was prepared having a CNF concentration of 8.05 mass % relative to the solid content and a viscosity of 320 dPa·s as measured by a Brookfield viscometer. The resulting coating composition was coated with a brush onto a cylinder resembling a propeller shaft. Drying was carried out at a predetermined temperature of 15° C. or higher and 30° C. or lower. A film thickness before drying (i.e., a wet film thickness) was 190 mm. After the coating, the coated product was dried in a stationary state. A film thickness after drying was 128 mm. As a result of coating, the coating composition was prone to cause scratches, but the coating was achieved. Further, due to a high viscosity of the coating composition, no dripping occurred.

### Example 2 (Corresponding to Test No. 11 in Table 1 Above)

Coating was performed the same as Example 1, except that the CNF concentration was changed to 6.71 mass % and the viscosity was changed to 260 dPa·s. A film thickness before drying (i.e., a wet film thickness) was 250 mm, and a film thickness after drying was 138 mm. As a result of coating, the coating composition was prone to cause scratches but the coating was achieved. Further, due to a high viscosity of the coating composition, no dripping occurred.

### Example 3 (Corresponding to Test No. 2 in Table 1 Above)

Coating was conducted the same as Example 1, except that the CNF concentration was changed to 0.08 mass %, the viscosity was changed to 2.8 dPa·s and further, the coating was performed by a spray instead of a brush. A film thickness before drying (i.e., a wet film thickness) was 80 mm, and the film thickness after drying was 45 mm. As a result of coating and drying, the coating was uniformly performed without causing any scratch. Further, the coating was able to be performed without dripping up to the film thickness of 80 mm or less before drying.

### Comparative Example 1 (Corresponding to Test No. 13 in Table 1 Above)

Coating was performed the same as Example 1, except that the CNF concentration was changed to 9.68 mass % and the viscosity was changed to 380 dPa s. Comparative Example 1 had a viscosity outside the range of the coating composition of the present disclosure. As a result of the evaluation, it was found that the coating composition did not come off the brush due to a high viscosity thereof, making coating impossible. Further, when physical force was applied to remove the coating composition from the brush, significant scratches were observed. However, due to the high viscosity, no dripping occurred.

### Comparative Example 2 (Corresponding to Test No. 1 in Table 1 Above)

Coating was conducted the same as Example 1, except that the CNF concentration was changed to 0.03 mass %, the viscosity was changed to 2.7 dPa·s, and the coating was performed by a spray instead of a brush. Comparative Example 2 had the CNF concentration relative to the solid content outside the range of the coating composition of the present disclosure. The maximum thickness of the film before drying (i.e., a wet film thickness) was 80 mm, and the thickness of the film after drying was 37 mm. As a result of coating and drying, dripping occurred immediately after the coating. However, spray coating was allowed for uniform coating.

### <Evaluation of Dripping Based on CNF Content>

### Example 4

Whether or not dripping occurred was evaluated the same as Example 1, except that the CNF concentration (i.e., solid content basis) was set to 0.1 mass %. As a result, no dripping occurred up to a film thickness before drying (i.e., a wet film thickness) of 190 mm. After drying, a glossy coated film 3 (see FIG. 1) having a thickness of 108 mm was obtained.

### Example 5

Evaluation was carried out the same as Example 4, except that an average fiber diameter of the CNFs was set to 100 nm or more and 1000 nm or less. As a result, similarly to Example 4, no dripping occurred up to 190 mm, but the texture changed to a matte tone. A film thickness after drying was 91 mm.

### Example 6

Evaluation was carried out the same as Example 4, except that the CNF concentration (i.e., solid content basis) was 0.5 mass %. As a result, similarly to Example 4, no dripping occurred up to 190 mm. After drying, a glossy coated film 3 having a thickness of 101 mm was obtained.

### Comparative Example 3

Evaluation was carried out the same as Example 4, except that CNF was not used. As a result, dripping occurred when the coating composition was coated up to 130 mm. After drying, a glossy coated film 3 was obtained.

### <Dispersibility Evaluation>

### Example 7

When the coating composition of Example 1 was visually checked, no CNF precipitates were observed. Therefore, it was confirmed that the CNFs were uniformly dispersed.

### Reference Example 1

Evaluation was carried out the same as Example 7, except that an average fiber diameter of the CNF was set to 100 nm or more and 1000 nm or less. As a result, it was found that the CNFs had precipitated and were not uniformly dispersed. Therefore, it was found that the average fiber diameter of CNF was preferably 100 nm or less in order to uniformly disperse the CNFs.

### <Water Resistance Evaluation>

Next, a water resistance test was conducted.

### Example 8 (Corresponding to Teat No. 6 in Table 1 Above)

The CNF and resin described at the beginning of the examples were used to adjust the viscosity to 3.5 Pa's so that the CNF concentration as a concentration of solid content was 1.13 mass %. A coating composition of the present disclosure was prepared by this procedure. The prepared coating composition was then used to prepare a coated member 1 (see FIG. 1). During the preparation, no dripping of the coating composition occurred. Further, the coating composition was easy to conduct coating and had good coating properties. A film thickness before drying (i.e., a wet film thickness) was 60 mm, and a film thickness after drying was 24 mm. The prepared coated member 1 was subjected to a water resistance test. The water resistance test was carried out by immersing the coated member 1 in water at a predetermined temperature for a predetermined period of time. As a result of the water resistance test, no swelling, peeling, rust and so on were observed in the appearance of the coated film 3 (see FIG. 1).

### Reference Example 2

Evaluation was carried out the same as Example 8, except that the CNF was not used. As a result, no swelling, peeling, rust, and so on were observed in the appearance of the coated film 3.

Since the CNF is hydrophilic, a coating composition containing the CNF tends to have increased water absorption and reduced water resistance. However, even though the coating composition of the present disclosure contains the CNF, the coating composition exhibits water resistance as excellent as that of the coating composition of Reference Example 2, which does not contain the CNF. A reason for this is that adjusting the fiber diameter and amount of the CNF does not significantly impair the inherent hydrophobicity of the coated film despite blending the CNF.

### <Acid Resistance Evaluation>

Next, an acid resistance test was conducted.

### Example 9 (Corresponding to Teat No. 4 in Table 1 Above)

The CNF and resin described at the beginning of the examples were used so that the CNF concentration was 0.15 mass % as a concentration of solid content, and the viscosity was adjusted to 2.8 dPa·s using the above mixed solvent. The coating composition of the present disclosure was prepared by this procedure. The prepared coating composition was then used to prepare a coated member 1 (see FIG. 1). During the preparation, no dripping of the coating composition occurred. Further, the coating composition was easy to conduct coating and had good coating properties. A film thickness before drying (i.e., a wet film thickness) was 50 mm, and a film thickness after drying was 25 mm. The prepared coated member 1 was subjected to an acid resistance test. The acid resistance test was carried out by immersing the coated member in an aqueous solution of strong acid at a predetermined temperature for a predetermined period of time. As a result of the acid resistance test, no swelling, peeling, rust and so on were observed in the appearance of the coated film 3 (see FIG. 1).

### Example 10

A coating composition according to the present disclosure was prepared the same as Example 9, except that the CNF concentration was changed to 0.5 mass %. A film thickness before drying (i.e., a wet film thickness) was 50 mm, and a film thickness after drying was 24 mm. When the prepared coated member 1 was subjected to the acid resistance test, swelling was observed in the appearance of the coated film 3.

### Example 11

A coating composition according to the present disclosure was prepared the same as Example 9, except that the CNF concentration was changed to 0.3 mass %. A film thickness before drying (i.e., a wet film thickness) was 50 mm, and a film thickness after drying was 27 mm. When the prepared coated member 1 was subjected to the acid resistance test, swelling was observed in the appearance of the coated film 3.

From the results of Example 9 and Reference Examples 2 and 3, it was found that the acid resistance was improved by setting the CNF concentration relative to the solid content to 0.3 mass % or less.

### DESCRIPTION OF REFERENCE NUMERALS

1. Coated structure
2. Substrate
3. Coated film

1. A coating composition which is coated on a substrate having a surface extending vertically downward, comprising:
a resin containing an epoxy resin as a main component; and
a cellulose nanofiber in which a functional group other than a hydroxyl group is introduced into a hydroxyl group site in a glucose unit at an introduction rate of 0% or more and 10% or less, wherein
a content of the cellulose nanofiber relative to a solid content is 0.05 mass % or more and 0.3 mass % or less, and
a viscosity of the coating composition is 2.8 dPa·s or more and 350 dPa·s or less.

2. The coating composition according to claim 1, wherein an amount of at least one of the epoxy resin and a solvent is adjusted so that a content of the cellulose nanofiber relative to the solid content is 0.12 mass % or more and 0.3 mass % or less.

3. The coating composition according to claim 1, wherein the substrate is a propeller shaft.

4. The coating composition according to claim 1, wherein an average fiber diameter of the cellulose nanofibers is 4 nm or more.

5. The coating composition according to claim 4, wherein an average fiber diameter of the cellulose nanofibers is 100 nm or less.

6. A coated member comprising a substrate having a surface extending vertically downward, and a coated film disposed on a surface of the substrate,
the coated film comprising:
a resin containing an epoxy resin as a main component; and
a cellulose nanofiber in which a functional group different from a hydroxyl group is introduced into a hydroxyl group site in a glucose unit at an introduction rate of 0% or more and 10% or less, wherein a concentration of the cellulose nanofiber relative to the coated film is 0.05 mass % or more and 0.3 mass % or less.

7. The coated member according to claim 6, wherein a thickness of the coated film is 30 mm or more.

8. The coated member according to claim 6, wherein the substrate includes a curved surface, and
the coated film is disposed on a surface of the curved surface.

9. The coated member according to claim 8, wherein the substrate is a propeller shaft.

10. A method for producing a coated member, comprising:
a step of coating a surface extending vertically downward of a stationary substrate with a coating composition which includes a resin containing an epoxy resin as a main component, and a cellulose nanofiber in which a functional group different from a hydroxyl group is introduced into a hydroxyl group site in a glucose unit at an introduction rate of 0% or more and 10% or less, wherein a concentration of the cellulose nanofiber relative to a solid content is 0.05 mass % or more and 0.3 mass % or less, and a viscosity of the coating composition is 2.8 dPa·s or more and 350 dPa·s or less; and
a step of drying the substrate coated with the coating composition in a stationary state.

11. The method for producing a coated member according to claim 10, wherein the coating step is carried out by using at least one of a spray and a brush.

12. The method for producing a coated member according to claim 10, wherein the coating step is carried out by the coating composition being coated so that a thickness of a coated film formed after drying is 30 mm or more.

13. The method for producing a coated member according to claim 10, wherein the coating step is carried out by the coating composition being coated onto a surface thus angled relative to a horizontal direction.

14. The method for producing a coated member according to claim 10, wherein the drying step is carried out in an atmosphere of 15° C. or higher and 30° C. or lower.
